(19) United States
(12) Patent Application Publication
(10) Pub. No.: US 2002/0064990 A1
(43) Pub. Date: May 30, 2002

(54) Connector

(76) Inventor: Sture Roos, Bergshamra (SE)

Correspondence Address: NIXON & VANDERHYE P.C., 1100 North Glebe Road, 8th Floor, Arlington, VA, 22201, US

(21) Appl. No.: 09/988,826

(22) Filed: Nov. 20, 2001

Related U.S. Application Data
(60) Provisional application No. 60/252,898, filed on Nov. 27, 2000.

(51) Int. Cl. H01R 4/24

(52) U.S. Cl. 439/397

(57) ABSTRACT

The present invention relates to a connector for connecting electrical wire having an conductor surrounded by insulation. According to the invention, the connector includes a printed circuit board, at least one arm and at least one contact member. The printed circuit board includes at least one board contact device. The at least one arm includes a first end, a second end and at least one cavity. The first end is attached to the printed circuit board so that the second end is movable. The cavity is adapted for receiving the electrical wire. The at least one contact member is attached on the printed circuit board and is adapted to engage into electrical contact with the conductor by making or entering at least one hole in the arm and the insulation.

### TECHNICAL FIELD

The present invention relates to a connector.

### DESCRIPTION OF RELATED ART

In some instances there is a need to be able to make new connections to distribution frames, printed circuit boards, etc in a fast and easy way.

An example will be given: In telephony, a main distribution frame (MDF) is a distribution frame on one part of which the external trunk cables entering a facility terminate, and on another part of which the internal user subscriber lines and trunk cabling to any intermediate distribution frames terminate. Subscriber lines may be e.g. public switched telephony network (PSTN) or Integrated Services Digital Network (ISDN).

Lately there has been a great interest in broadband access for subscribers. If a broadband modem that includes a split filter is to be connected, this means that the subscriber loop must be opened. This is done by adding two and removing one electrical wire—often called jumper wires—for the subscriber in the MDF. This requires a lot of work and requires special tools. If pre-provisioning for broadband services is to be made, this means that a large number of reconnections have to be done in the MDF even if you are not sure that the subscriber wants broadband. If it later turns up that the subscriber doesn't want to have the service, then all the jumper wires must be restored to their initial connections.

If test equipment is to be connected to the subscriber loop it is possible to instead use a patch cord, which is a cable with prefabricated connectors in the ends. For test equipment only a few connections need to be made. However, in pre-provisioning of lines for broadband access a large number of patch cords of different lengths would be needed, which is not very flexible.

### SUMMARY

Earlier solutions suffer from the disadvantages that connections take time, are complicated and/or may need special tools.

The purpose with the present invention is to provide a connector for fast connections and deconnections, which can be used to easily connect electrical wires to the connector without any need for special tools.

This is solved in the present invention by using a connector including a printed circuit board, at least one arm and at least one contact member. The printed circuit board further includes at least one board contact device. The arm includes a first end, a second end and at least one cavity, wherein the first end is attached to the printed circuit board so that the second end is movable. The cavity is adapted for receiving an electrical wire. The contact member is attached on the printed circuit board and is adapted to engage into electrical contact with the conductor by making or entering at least one hole in the arm and the insulation.

Further, the invention may also be used when an electrical wire is to be connected directly to a printed circuit board. In this case the printed circuit board is not a part of the connector, but the connector includes only the arm or arms and the contact member or members, which are attached to the printed circuit board. Further, there is not necessarily any board contact device, because it is the printed circuit board that is the main thing in this embodiment.

The advantages with the present invention are that electrical wires may be connected and deconnected in a fast and easy way, without the need for any tools.

The invention will now be described in more detail with the aid of preferred embodiments and with reference to enclosed drawings.

### BRIEF DESCIPTION OF THE DRAWINGS

FIG. 1a shows a side cross-section view of a connector according to the present invention, with two different embodiments of how an arm of the connector may look. The Figure is a cross-section B-B of FIG. 1b.

FIG. 1b shows a top cross-section view of FIG. 1a. The Figure is a cross-section A-A of FIG. 1a.

FIG. 2 shows a first embodiment of a contact member.

FIG. 3 shows a second embodiment of a contact member.

FIG. 4 shows the same Figure as FIG. 1a, but with electrical wires inserted in the connector.

FIG. 5a shows a side cross-section view of FIG. 4 after mounting. The Figure is a cross-section D-D of FIG. 5b.

FIG. 5b shows a top cross-section view of FIG. 5a. The Figure is a cross-section C-C of FIG. 5a.

### DETAILED DESCRIPTION OF EMBODIMENTS

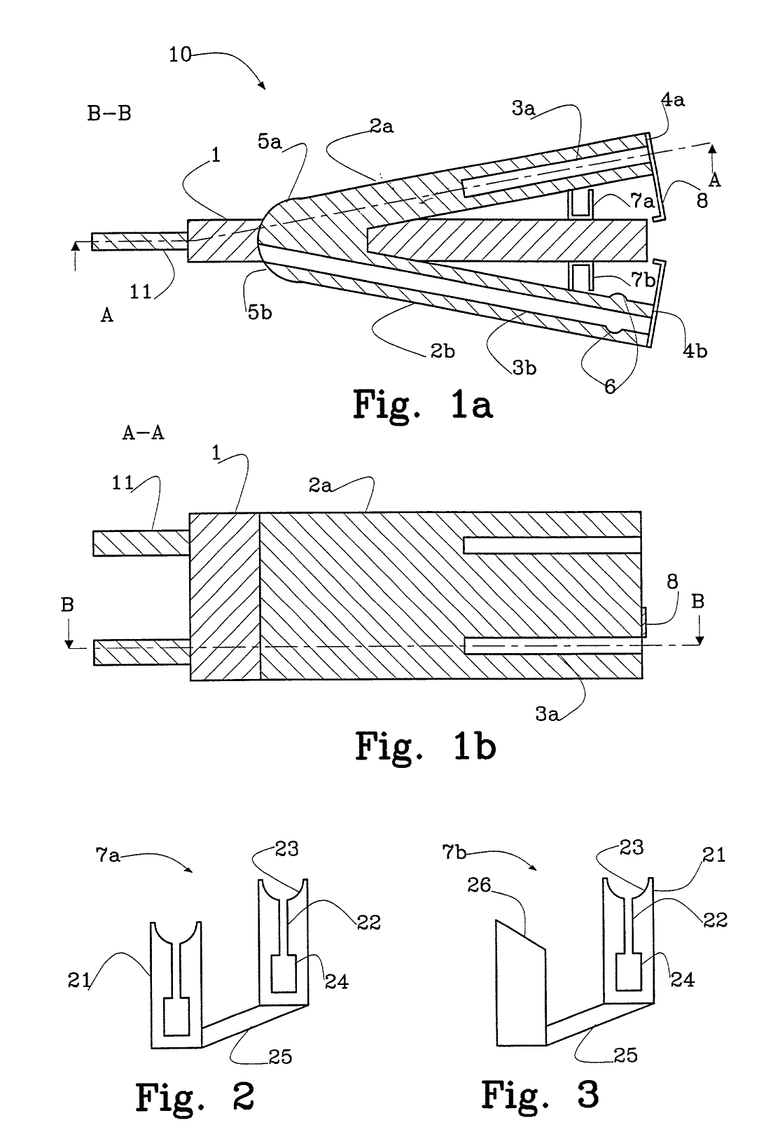

FIG. 1a and 1b show a side cross-section view and a top cross-section view of a connector 10 according to the present invention. The connector 10 includes a printed circuit board 1 or similar and at least one arm 2a, 2b. Two different embodiments of arms 2a, 2b are shown in FIG. 1a. Said arm 2a, 2b is attached to the printed circuit board 1 with its inner end 5a, 5b, while its outer end 4a, 4b is free and movable. The arm 2a, 2b is made of an isolating material, such as plastic.

Each arm includes at least one cavity 3a, 3b. The embodiment in FIG. 1b shows an example where an arm includes two cavities. This may be advantageous in cases where the connections come in pairs. The cavity 3a, 3b is intended for receiving an insulated electrical wire, which normally includes a conductor with surrounding insulation. The cavity 3a, 3b, which starts in or near the outer end 4a, 4b of the arm 2a, 2b, may either have a stop somewhere in the arm 2a or go right through the arm 2b to the inner end 5a, 5b.

In order for the wire to stay in place in the cavity 3a, 3b, the cavity 3a, 3b may be provided with some sort of stress-reliever 6. This will be described later.

The printed circuit board 1 is further provided with at least one contact member 7a, 7b, e.g. a slot contact or IDC contact. This at least one contact member 7a, 7b is connected to at least one circuit on the printed circuit board 1 and is made by a conductive material. FIGS. 2 and 3 show how such a contact member 7a, 7b may look. This will also be described later.

The arm 2a, 2b is further provided with some sort of lock device 8. In FIG. 1a is shown a hook 8, which is meant to hook either on the printed circuit board 1 or on a second arm 2b. Another alternative could be to use a spring or similar.

The printed circuit board 1 is further provided with some sort of board contact device 11, e.g. one or more contacts or pins 11 for connection with e.g. a distribution frame or a printed circuit board or similar.

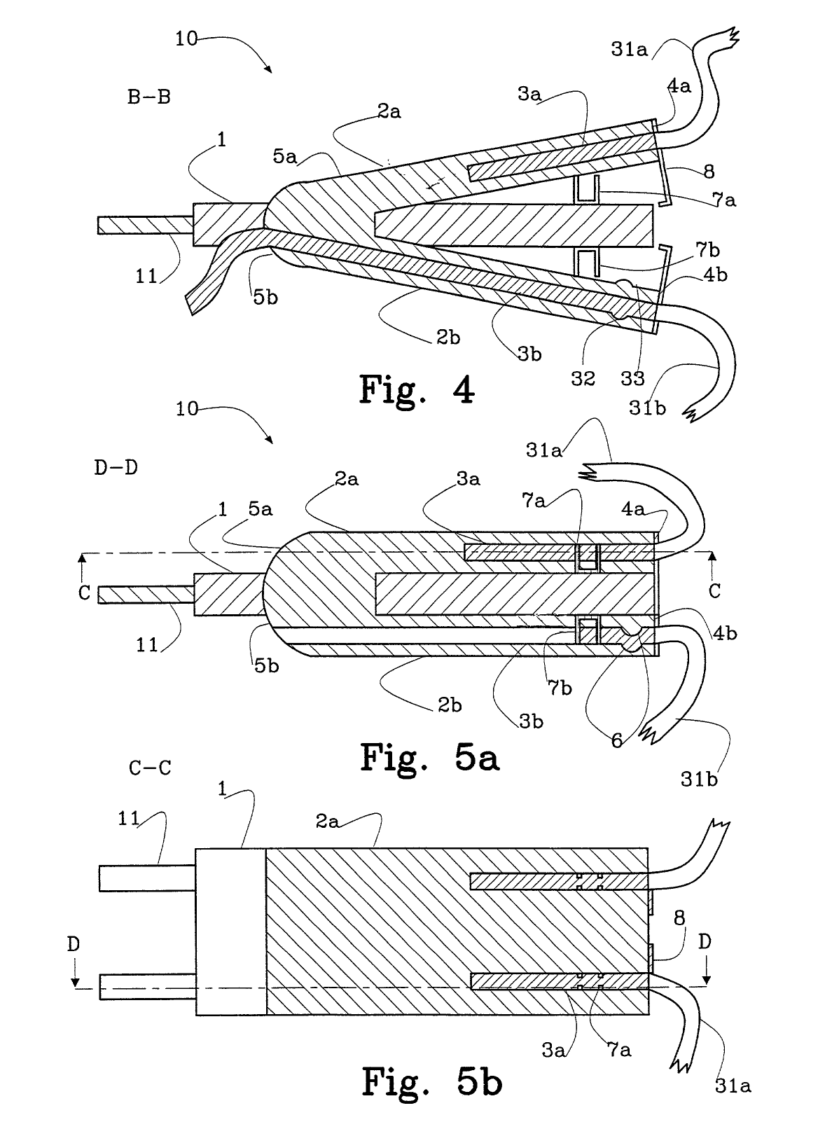

For mounting of an electrical wire the situation is first as in FIG. 1a with the arm 2a, 2b open. Then an electrical wire 31a, 31b is inserted in the cavity 3a, 3b as shown in FIG. 4. Then the arm 2a, 2b is pressed against the printed circuit board 1 and locked in a closed position with the locking device 8 as shown in FIG. 5a and FIG. 5b.

When the arm 2a, 2b is pressed against the printed circuit board 1, then the contact member 7a, 7b is pressed into the arm 2a, 2b. The arm 2a, 2b may be prefabricated with at least one hole to receive the contact member 7a, 7b. An easier solution is that the material in the arm 2a, 2b is so soft that at least one hole is created by the contact member 7a, 7b, when the arm 2a, 2b is pressed against the printed circuit board 1.

The contact member 7a, 7b thus meets the electrical wire 31a, 31b and engages into electrical contact with the conductor in the electrical wire 31a, 31b by making at least one hole in the insulation. It is conceivable, but not very practical, to make a hole in the insulation in advance instead. Thus, the conductor of the electrical wire 31a, 31b is now in contact with at least one circuit on the printed circuit board 1.

The contact member 7a, 7b may look in different ways, as earlier mentioned. In FIG. 2 is shown a first embodiment of a contact member 7a having two contact blades 21 connected to each other with a common blade 25. It is conceivable to use one or more contact blades 21. The reason for using more than one contact blade 21 is for redundancy, if e.g. it should happen that one contact blade becomes damaged and thus does not reach contact with the electrical wire when mounting is performed.

Each contact blade 21 is provided with a slot 22 for receiving the electrical wire. The width of the slot 22 is preferably smaller than the diameter of the electrical wire. This is to ensure that the insulation of the electrical wire is sufficiently cut, so that the contact member 7a properly engages into electrical contact with the conductor of the electrical wire. The slot 22 may be wider in its outer end 23 so as to catch the electrical wire in a proper way. Further, the slot 22 may be wider in its inner end 24 so as to keep the electrical wire in place and in contact.

In FIG. 3 is shown a second embodiment of a contact member 7b. The contact member 7b has one contact blade as described in 7a and further a knife blade 26 that is used to cut the electrical wire.

An alternative solution could be to use a contact member in the form of a spike or similar, which then enters in the middle of the electrical wire and makes contact. However, this is a less secure solution than those in FIGS. 2 and 3 and will further be difficult, if not impossible, to implement if the diameter of the electrical wire is small.

In FIG. 4 and 5a it is further shown how the stress-reliever 6 works. The stress-reliever 6 in FIG. 4 includes a recess 32 in the cavity 3b and a bump 33 on the arm 2b. If the material in the arm 2b is sufficiently soft, then when then arm 2b is pressed against the printed circuit board 1, the bump 33 will press a part of the electrical wire 31b into the recess 32. Thus, the electrical wire 31b will be kept in place. Of course, other stress relievers are conceivable, e.g. to use a screw or a spring instead of the bump and the recess or to simply make the cavity conical. Another alternative could be to make the cavity in some way bent from the beginning, which however makes the mounting of the electrical wire more difficult.

When the at least one electrical wire is connected to the connector, then the connector may further be connected to whatever it is to be connected to e.g. a distribution frame.

If the electrical wire is to be removed again, all that is necessary is to loosen the lock device and the stress-reliever, if any and if necessary, and to pull out the electrical wire again. Note that connecting and deconnecting is performed very fast and without any need for special tools. Neither is there any need for using special electrical wires having special contacts in the end, nor is there any need to strip the electrical wire, which also simplifies and makes things cheaper.

Another embodiment of this invention is when an electrical wire is to be connected directly to a printed circuit board. In this case the printed circuit board is not a part of the connector, but the connector includes only the at least one arm and the at least one contact member, which are attached to the printed circuit board. Further, there is not necessarily any board contact device, because it is the printed circuit board that is the main thing in this embodiment.

1. Connector (10) for connecting electrical wire (31a, 31b) having an conductor surrounded by insulation, characterized
in that the connector (10) includes a printed circuit board (1), at least one arm (2a, 2b) and at least one contact member (7a,7b),
in that the printed circuit board (1) includes at least one board contact device (11),
in that the at least one arm (2a, 2b) includes a first end (5a, 5b), a second end (4a, 4b) and at least one cavity (3a, 3b),
in that the first end (5a, 5b) is attached to the printed circuit board (1) so that the second end (4a, 4b) is movable,
in that the cavity (3a, 3b) is adapted for receiving the electrical wire (31a, 31b), and
in that the at least one contact member (7a, 7b) is attached on the printed circuit board (1) and is adapted to engage into electrical contact with the conductor by making or entering at least one hole in the arm (2a, 2b) and the insulation.

2. Connector for connecting an electrical wire (31a, 31b) to a printed circuit board (1), said electrical wire (31a, 31b) including an conductor surrounded by insulation, characterized
in that the connector includes at least one arm (2a, 2b) and at least one contact member (7a, 7b),
in that the at least one arm (2a, 2b) includes a first end 5a, 5b), a second end (4a, 4b) and at least one cavity (3a, 3b),
in that the first end (5a, 5b) is adapted for mounting on the printed circuit board (1) so that the second end (4a, 4b) is movable,
in that the cavity (3a, 3b) is adapted for receiving the electrical wire (31a, 31b) and
in that the at least one contact member (7a, 7b) is adapted for mounting on the printed circuit board (1), so that it can engage into electrical contact with the conductor by making or entering at least one hole in the arm (2a, 2b) and the insulation.

3. Connector according to claim 1 or 2, characterized in that the at least one arm (2a, 2b) is provided with a stressreliever (6).

4. Connector according to any of the claims 1-3, characterized in that the at least one arm (2a, 2b) is provided with a locking device (8).

5. Connector according to any of the claims 1-4, characterized in that the contact member (7a, 7b) is a slot contact.

6. Method for electrically connecting an electrical wire (31a, 31b) with a connector (10), said electrical wire (31a, 31b) including a conductor surrounded by insulation, characterized by the following steps, wherein the connector includes a printed circuit board (1), at least one contact member (7a, 7b) and at least one arm (2a, 2b) with at least one cavity (3a, 3b):
inserting one end of the electrical wire (31a,31b) in the cavity (3a, 3b); and
pressing the arm (2a, 2b) against the printed circuit board (1) so that the contact member (7a, 7b) makes or enters at least one hole in the arm (31a, 31b) and the insulation, whereupon the contact member (7a, 7b) is engaged into electrical contact with the conductor.

7. Method for electrically connecting an electrical wire (31a, 31b) with a connector (10), said electrical wire (31a, 31b) including a conductor surrounded by insulation, characterized by the following steps, wherein the connector (10) includes at least one contact member (7a, 7b) and at least one arm (2a, 2b) with at least one cavity (3a, 3b), said at least one contact member (7a, 7b) and said at least one arm (2a, 2b) being mounted on a printed circuit board (1):
inserting one end of the electrical wire in the cavity (3a, 3b); and
pressing the arm (2a, 2b) against the printed circuit board (1) so that the contact member (7a, 7b) makes or enters at least one hole in the arm (2a, 2b) and the insulation, whereupon the contact member (7a, 7b) is engaged into electrical contact with the conductor.
